(19) United States
(12) Patent Application Publication
(10) Pub. No.: US 2025/0117525 A1
(43) Pub. Date: Apr. 10, 2025

(54) ENCRYPTION DEVICE AND METHOD THEREOF UTILIZING WRITE LOCK, KEY LOCK, AND DIGEST INFORMATION TO INCREASE SECURITY

(71) Applicant: Nuvoton Technology Corporation, Hsinchu Science Park (TW)

(72) Inventors: Kun-Yi WU, Tainan City (TW); Yu-Shan LI, Tainan City (TW)

(21) Appl. No.: 18/401,478

(22) Filed: Dec. 30, 2023

(30) Foreign Application Priority Data
Jul. 7, 2023 (TW) 112125379

(51) Int. Cl. G06F 21/79; G06F 21/60; G06F 21/64

(52) U.S. Cl. CPC G06F 21/79; G06F 21/602; G06F 21/64

(57) ABSTRACT

An encryption device is provided herein, which includes a memory array and a memory control device. The memory array is configured to store lock data. The memory control device determines whether the lock data is equal to a predetermined value according to an operation instruction. When the memory control device determines that the lock data is equal to the predetermined value, the memory control device performs a logic operation on the write data and an output key to generate encrypted write data, and writes the encrypted data into the memory array as ciphertext.

### CROSS REFERENCE TO RELATED APPLICATIONS

This application claims priority of Taiwan Patent Application No. 112125379, filed on Jul. 7, 2023, the entirety of which is incorporated by reference herein.

### BACKGROUND OF THE INVENTION

### Field of the Invention

The present invention relates to an encryption device and a method thereof. In particular, it relates to an encryption device and a method thereof which utilize the write lock, the key lock, and the digest information to increase security.

### Description of the Related Art

In cryptography, the term “encryption” refers to a process of changing plaintext into incomprehensible ciphertext to protect its content. Only a device having a decryption method can restore the ciphertext to normal readable content through a decryption process. Ideally, only authorized personnel can read the information conveyed by the ciphertext. Encryption itself cannot prevent the interception of transmitted information, but it can prevent the interceptor from understanding the content of the information.

### BRIEF SUMMARY OF THE INVENTION

The present invention proposes encryption devices and operation methods thereof, which set a write lock according to user's need, so as to strengthen the protection of the content of the ciphertext and prevent the possibility of it being tampered with. In addition, the encryption device proposed by the present invention uses a Cipher-block chaining Message Authentication Code (CBC-MAC) mode to generate digest information and store the digest information in the memory array. This provides an additional protection for the ciphertext to ensure the security and integrity of internal programs. Furthermore, the encryption device proposed herein is locked with keys, so that the digest information must be confirmed to unlock the subsequent decryption process during the read operation, so as to prevent data that has been tampered with from flowing into the encryption device.

In an embodiment, an encryption device comprising a memory array and a memory control device is provided. The memory array is configured to store lock data. The memory control device determines whether the lock data is equal to a predetermined value according to an operation instruction. When the memory control device determines that the lock data is equal to the predetermined value, the memory control device performs a logic operation on write data and an output key to generate encrypted write data, and writes the encrypted write data to the memory array as ciphertext.

According to an embodiment of the invention, the memory control device comprises a first register, a second register, a third register, a first comparator, a second comparator, a bus interface, a memory interface, a buffer, a first logic gate, a second logic gate, and a controller. The first register is configured to store a write lock. The second register is configured to store a key lock. The third register is configured to store a message authentication code of a message authentication code memory address in the memory array. The first comparator is configured to compare the lock data with the predetermined value to generate a first comparison result. The second comparator is configured to compare digest information with the message authentication code to generate a second comparison result. The bus interface receives the operation instruction, an encryption enable signal, the write data, an operating memory address, an encrypted memory address, a key, a random number, and setting information. The key, the random number, and the setting information correspond to the encrypted memory address. The encrypted memory address comprises a starting memory address, an end memory address, and a message authentication code memory address. The encrypted data is stored in the starting memory address and the lock data is stored in the end memory address. The memory interface is coupled to the memory array. The buffer is coupled to the memory interface. When the first comparator compares the lock data with the predetermined value, the buffer temporarily stores the lock data. The buffer temporarily stores the encrypted write data and the ciphertext. The first logic gate performs an exclusive OR logic operation on the write data and the output key to generate the encrypted write data. The second logic gate performs the exclusive OR logic operation on the ciphertext and the output key to generate read data. The controller controls the memory array using a memory control signal through the memory interface according to the operation instruction and the operation memory address, and accesses the memory array through the buffer and the memory interface. The controller determines whether the lock data is equal to the predetermined value according to the first comparison result. When the lock data is equal to the predetermined value, the controller enables the first register using a write lock enable signal and sets the write lock to an unlocked state using a write lock input signal. When the lock data is not equal to the predetermined value, the controller sets the write lock to a locked state.

According to an embodiment of the invention, the memory control device further comprises a password device. The password device comprises a fourth register, a first multiplexer, a determination unit, a first encryption unit, a second encryption unit, a cipher unit, a second multiplexer, and a third logic gate. The fourth register is configured to store the encryption enable signal, the encrypted memory address, the key, the random number, and the setting information. The first multiplexer outputs the key, the random number, or the setting information according to a determination signal. When the determination unit determines that the operating memory address is in the encrypted memory address, the determination unit generates the determination signal and a key enable signal according to the key lock, the write lock, an operation signal, a message authentication code signal, and a protected area selection signal. The first encryption unit performs a first encryption mode calculation on the first random number output by the first multiplexer and the operating memory address to generate a first encryption result. The second encryption unit receives the ciphertext stored in the memory array and the lock data, and performs a second encryption mode calculation on the ciphertext, the lock data, the setting information output by the first multiplexer, and a starting memory address and an end memory address of the encrypted memory address to generate a second encryption result. The cipher unit uses the first encryption result and the key output by the first multiplexer to generate a key stream, or uses the second encryption result and the key output by the first multiplexer to generate digest information. The second multiplexer provides either the first encryption result or the second encryption result to the cipher unit according to an encryption selection signal generated by the controller. The third logic gate performs a logic AND operation on the key stream and the key enable signal to generate the output key.

According to an embodiment of the invention, when a user sets the encryption enable signal to an enabled state through the bus interface, the controller sets the write lock and the key lock to a locked state. The controller does not write the write data into the encrypted memory address according to the write lock being in the locked state. The third logic gate does not output the key stream as the output key according to the key enable signal being in the locked state. The user further sets the encrypted memory address, the key, the random number, and the setting information through the bus interface.

According to an embodiment of the invention, the controller writes a value into the end memory address as the lock data, and the value and the predetermined value are different. The controller further reads the ciphertext and the lock data being the value from the encrypted memory address. The cipher unit generates the digest information corresponding to the encrypted memory address. The controller writes the digest information generated by the cipher unit into the message authentication code memory address as the message authentication code, and sets the key lock of the encrypted memory address to an unlocked state.

According to an embodiment of the invention, the controller selects the encrypted memory address using the protected area selection signal to verify the message authentication code and to enable the message authentication code signal. The controller reads the ciphertext, the lock data, and the message authentication code of the encrypted memory address. The cipher unit generates the digest information according to the ciphertext and the lock data. The second comparator compares the digest information with the message authentication code. When the digest information is equal to the message authentication code, the controller sets the key lock to the unlocked state. When the digest information is not equal to the message authentication code, the controller sets the key lock to the locked state.

According to an embodiment of the invention, the determination unit determines whether the operating memory address is in the encrypted memory address. When the operating memory address is in the encrypted memory address, when the operation signal is in a write operation, and when the write lock is in the unlocked state, the determination unit enables the key enable signal. The cipher unit uses the first encryption result generated by the first encryption unit and the key to generate the key stream, and the third logic gate outputs the key stream as the output key according to the enabled key enable signal. The first logic gate encrypts the write data using the output key to generate encrypted write data. The controller writes the encrypted write data to the operating memory address of the memory array as encrypted data.

According to an embodiment of the invention, the determination unit determines whether the operating memory address is in the encrypted memory address. When the operating memory address is in the encrypted memory address, the operation signal is in a reading state, and the key lock is in the unlocked state, the determination unit enables the key enable signal. The third logic gate outputs the key stream as the output key according to the key enable signal. The second logic gate decrypts the ciphertext stored in the operating memory address of the memory array by using the output key as the read data.

According to an embodiment of the invention, the first encryption mode calculation is a counter mode, wherein the second encryption mode calculation is a Cipher-block chaining Message Authentication Code (CBC-MAC) mode.

In another embodiment, an operation method adapted to an encryption device is provided. The encryption device comprises a memory array, and the memory array stores lock data. The operation method comprises the following steps. It is determined whether lock data is equal to a predetermined value. When it is determined that the lock data is equal to the predetermined value, a write lock is set to an unlocked state. When the write lock is in the unlocked state, write data is encrypted with an output key to generate encrypted write data. The encrypted write data is written into the memory array.

According to an embodiment of the invention, the operation method further comprises the following steps. When an encrypted memory address is set, a setting method is executed. When the lock data is compared, a comparison method is executed. When a message authentication code of the encrypted memory address is programmed, a programming method is executed. When the message authentication code is verified, a verification method is executed. When performing a write operation on the memory array, a writing method is executed. When performing a read operation on the memory array, a reading method is executed. Before the writing method is executed, the setting method and the comparison method must be sequentially executed at least once. Before the reading method is executed, the setting method, the programming method, and the verification method must be sequentially executed at least once.

According to an embodiment of the invention, the setting method further comprises the following steps. The encrypted memory address, a key, a random number, setting information, and an encrypted enable signal are set through a bus interface. The key, the random number, and the setting information correspond to the encrypted memory address. The encrypted memory address comprises a starting memory address, an end memory address, and a message authentication code memory address. The write lock and a key lock corresponding to the encrypted memory address are set to a locked state.

According to an embodiment of the invention, the comparison method further comprises the following steps. The lock data of the encrypted memory address is read. The lock data is stored in the end memory address. It is determined whether the lock data is equal to the predetermined value. When it is determined that the lock data is equal to the predetermined value, the write lock is set to the unlocked state. When it is determined that the lock data is not equal to the predetermined value, the write lock is set to the locked state.

According to an embodiment of the invention, the programming method further comprises steps. A value is written into the end memory address as the lock data. The value is not equal to the predetermined value. The encrypted memory address is selected to be programmed. The ciphertext and the lock data of the encrypted memory address of the memory array are read. Digest information of the encrypted memory address is generated according to the ciphertext, the lock data, the starting memory address, the end memory address, and the setting information. The digest information is written to the message authentication code memory address. After the digest information is written, the key lock is set to the unlocked state.

According to an embodiment of the invention, the step of generating the digest information of the encrypted memory address according to the ciphertext, the lock data, the starting memory address, the end memory address, and the setting information further comprises the following steps. An encryption mode calculation is performed on the ciphertext, the lock data, the starting memory address, the end memory address, and the setting information to generate an encryption result. The digest information is generated according to the encryption result and the key. The encryption mode calculation is a Cipher-block chaining Message Authentication Code (CBC-MAC) mode. According to an embodiment of the invention, the verification method further comprises the following steps. The encrypted memory address is selected to be verified. The ciphertext, the lock data, and the message authentication code of the encrypted memory address of the memory array are read. The digest information of the encrypted memory address is generated according to the ciphertext, the lock data, the starting memory address, the end memory address, and the setting information. It is determined whether the message authentication code is equal to the digest information. When the message authentication code is equal to the digest information, the key lock of the encrypted memory address is set to the unlocked state. When the message authentication code is not equal to the digest information, the key lock of the encrypted memory address is set to the locked state.

According to an embodiment of the invention, the writing method further comprises the following steps. An operating memory address is received for a write operation. It is determined whether the operating memory address is in the encrypted memory address. When the operating memory address is in the encrypted memory address, determining whether the write lock is in the unlocked state. When the write lock is in the unlocked state, a key stream is generated according to the operating memory address, the random number, and the key. The write data is encrypted using the key stream to generate the ciphertext. The ciphertext is written to the memory array.

According to an embodiment of the invention, the step of generating the key stream according to the operating memory address, the random number, and the key further comprises the following steps. An encryption mode calculation is performed on the operating memory address and the random number to generate an encrypted result. The key stream is generated according to the encryption result and the key. A key enable signal is enabled according to the operating memory address being in the encrypted memory address and the write lock being in the unlocked state. The key stream is output as an output key according to the key enable signal. The output key is further configured to encrypt the write data. The encryption mode calculation is a counter mode.

According to an embodiment of the invention, the reading method further comprises the following steps. An operating memory address is received to perform a read operation. It is determined whether the operating memory address is in the encrypted memory address. When the operating memory address is in the encrypted memory address, a determination is made as to whether the key lock is in the unlocked state. When the key lock is in the unlocked state, a key stream is generated according to the operating memory address, the random number, and the key. The ciphertext is decrypted by using the key stream to generate read data. The read data is provided to a host.

According to an embodiment of the invention, the reading method further comprises the following steps. When the operating memory address is not in the encrypted memory address, the key stream is not generated. When the key lock is in the locked state, the key stream is not generated. The ciphertext of the operating memory address of the memory array is directly read as the read data.

A detailed description is given in the following embodiments with reference to the accompanying drawings.

### BRIEF DESCRIPTION OF DRAWINGS

The invention can be more fully understood by reading the subsequent detailed description and examples with references made to the accompanying drawings, wherein:

FIG. 1 is a block diagram showing an encryption device in accordance with an embodiment of the present invention;

FIG. 2 shows a mapping table of encrypted memory address, key, random number, and setting information in accordance with an embodiment of the present invention;

FIG. 3 is a flow chart showing the operation method in accordance with an embodiment of the present invention;

FIG. 4 is a flow chart showing a setting method in accordance with an embodiment of the present invention;

FIG. 5 is a flow chart showing a comparison method in accordance with an embodiment of the present invention;

FIG. 6 is a flow chart showing a programming method in accordance with an embodiment of the present invention;

FIG. 7 is a flow chart showing a verification method in accordance with an embodiment of the present invention;

FIG. 8 is a flow chart showing a writing method in accordance with an embodiment of the present invention; and

FIG. 9 is a flow chart showing a reading method in accordance with an embodiment of the present invention.

### DETAILED DESCRIPTION OF THE INVENTION

The following description is made for the purpose of illustrating the general principles of the disclosure and should not be taken in a limiting sense. The scope of the disclosure is determined by reference to the appended claims.

In the following detailed description, for purposes of explanation, numerous specific details and embodiments are set forth in order to provide a thorough understanding of the present disclosure. The use of like and/or corresponding numerals in the drawings of different embodiments does not suggest any correlation between different embodiments.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In addition, in this specification, relative spatial expressions are used. For example, “lower”, “bottom”, “higher” or “top” are used to describe the position of one element relative to another. It should be appreciated that if a device is flipped upside down, an element that is “lower” will become an element that is “higher”.

It should be understood that, although the terms first, second, third etc. may be used herein to describe various elements, components, regions, layers, portions and/or sections, these elements, components, regions, layers, portions and/or sections should not be limited by these terms. These terms are only used to distinguish one element, component, region, layer, portion or section from another element, component, region, layer or section. Thus, a first element, component, region, layer, portion or section in the specification could be termed a second element, component, region, layer, portion or section in the claims without departing from the teachings of the present disclosure.

It should be understood that this description of the exemplary embodiments is intended to be read in connection with the accompanying drawings, which are to be considered part of the entire written description. The drawings are not drawn to scale. In addition, structures and devices are shown schematically in order to simplify the drawing.

The terms “approximately”, “about” and “substantially” typically mean a value is within a range of +/−20% of the stated value, more typically a range of +/−10%, +/−5%, +/−3%, +/−2%, +/−1% or +/−0.5% of the stated value. The stated value of the present disclosure is an approximate value. Even there is no specific description, the stated value still includes the meaning of “approximately”, “about” or “substantially”.

Unless defined otherwise, all technical and scientific terms used herein have the same meaning as commonly understood by one of ordinary skill in the art to which this disclosure belongs. It should be appreciated that, in each case, the term, which is defined in a commonly used dictionary, should be interpreted as having a meaning that conforms to the relative skills of the present disclosure and the background or the context of the present disclosure, and should not be interpreted in an idealized or overly formal manner unless so defined.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

In the drawings, similar elements and/or features may have the same reference number. Various components of the same type can be distinguished by adding letters or numbers after the component symbol to distinguish similar components and/or similar features.

In addition, in some embodiments of the present disclosure, terms concerning attachments, coupling and the like, such as “connected” and “interconnected,” refer to a relationship wherein structures are secured or attached to one another either directly or indirectly (for example, electrically connection) via intervening structures, as well as both movable or rigid attachments or relationships, unless expressly described otherwise.

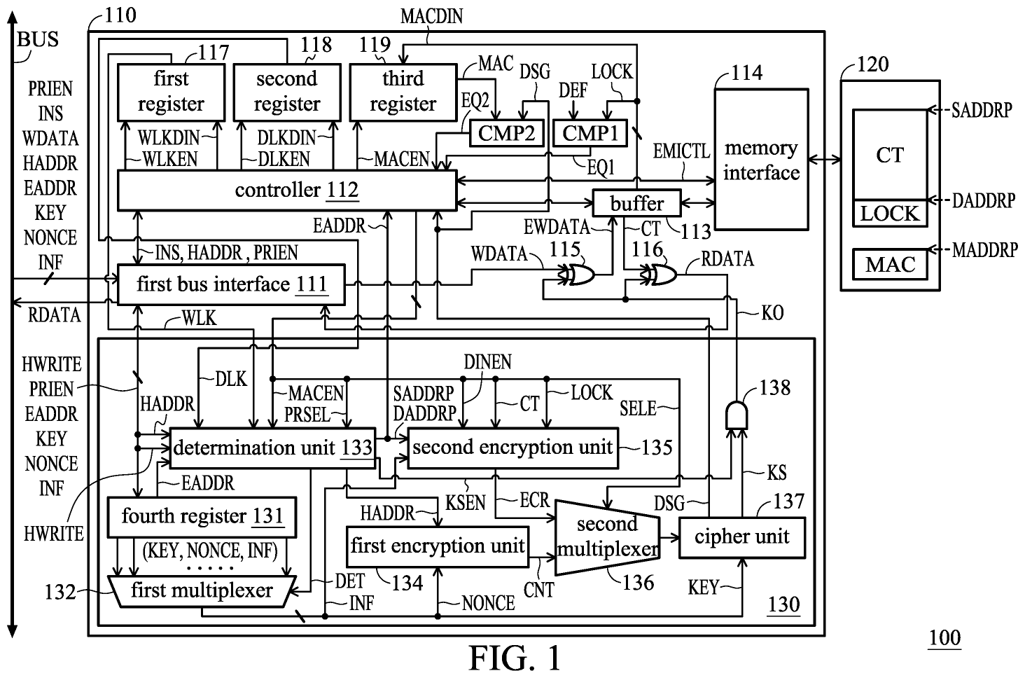

FIG. 1 is a block diagram showing an encryption device in accordance with an embodiment of the present invention. As shown in FIG. 1, the encryption device 100 includes a memory control device 110 and a memory array 120. The memory control device 110 includes a first bus interface 111, a controller 112, a buffer 113, a memory interface 114, a first logic gate 115, a second logic gate 116, and a password device 130.

The first bus interface 111 receives the operation instruction INS, the write data WDATA, the operating memory address HADDR, and the encrypted memory address EADDR from the bus BUS, and the first bus interface 111 transmits the operation instruction INS and the operating memory address HADDR to the controller 112, so that the controller 112 performs the read operation or the write operation on the operating memory address HADDR of the memory array 120 through the buffer 113 and the memory interface 114 according to the operation instruction INS and the operating memory address HADDR. When the operating memory address HADDR is located in the encrypted memory address EADDR, data written to or read from the operating memory address HADDR needs to be encrypted or decrypted.

According to an embodiment of the present invention, when the controller 112 performs a write operation on the memory array 120 according to the operation instruction INS and the operating memory address HADDR is located in the encrypted memory address EADDR, the controller 112 controls the memory array 120 through the memory interface 114 by the memory control signal EMICTL, the first logic gate 115 performs a mutually exclusive OR logic operation on the write data WDATA and the output key KO to generate encrypted write data EWDATA, and writes the encrypted write data EWDATA into the operating memory address HADDR of the memory array 120 as the ciphertext CT through the buffer 113 and the memory interface 114.

According to another embodiment of the present invention, when the controller 112 performs a read operation on the memory array 120 according to the operation instruction INS and the operating memory HADDR is located in the encrypted memory address EADDR, the controller 112, by the memory control signal EMICTL, controls the memory array 120 through the memory interface 114, reads the ciphertext CT from the operating memory address HADDR of the memory array 120 through the memory interface 114 which is temporarily stored in the buffer 113, and performs a mutually exclusive OR logic operation on the ciphertext CT and the output key KO by the second logic gate 116 to generate the read data RDATA that is sent to the host through the first bus interface 111 and the bus BUS.

As shown in FIG. 1, the encrypted memory address EADDR includes the initial memory address SADDRP and the end memory address DADDRP, and the memory array 120 stores the ciphertext CT in the memory between the initial memory address SADDRP and the end memory address DADDRP minus 1, and the lock data LOCK is stored in the end memory address DADDRP. The encrypted memory address EADDR further includes the message authentication code memory address MADDRP for storing the message authentication code MAC. The functions of the lock data LOCK and the message authentication code MAC will be described in detail below.

As shown in FIG. 1, the memory control device 110 further includes a first register 117, a second register 118, a third register 119, a first comparator CMP1, and a second comparator CMP2. The controller 112 uses the write lock enable signal WLKEN to allow the first register 117 to be written into, and uses the write lock input signal WLKDIN to set the write lock WLK stored in the first register 117 to a locked state or an unlocked status.

The controller 112 uses the key lock enable signal DLKEN to allow the second register 118 to be written, and uses the key lock input signal DLKDIN to set the key lock DLK stored in the second register 118 to a locked state or an unlocked state. When the controller 112 accesses the message authentication code MAC stored in the memory array 120, the controller 112 temporarily stores the message authentication code memory address MADDRP of the message authentication code MAC temporarily stored in the buffer 113, allows the third register 119 to be written by the message authentication code enable signal MACEN, and then the message authentication code MAC is written into the third register 119 through the buffer 113 by using the message authentication code input signal MACDIN.

When the controller 112 accesses the lock data LOCK stored in the end memory address DADDRP of the memory array 120, the read lock data LOCK is first temporarily stored in the buffer 113, and the first comparator CMP1 compares the lock data LOCK temporarily stored in the buffer 113 with the default value DEF to generate the first comparison result EQ1. The first comparison result EQ1 is provided to the controller 112. The second comparator CMP2 is configured to compare the message authentication code MAC stored in the third register 119 with the digest information DSG to generate a second comparison result EQ2, and provides the second comparison result EQ2 to the controller 112. The controller 112 determines whether the lock data LOCK is equal to the default value DEF according to the first comparison result EQ1, and determines whether the message authentication code MAC is equal to the digest information DSG according to the second comparison result EQ2. According to some embodiments of the present invention, the default value DEF can be set by the user through the bus BUS.

As shown in FIG. 1, the password device 130 is configured to generate the output key KO and the digest information DSG, and includes a fourth register 131, a first multiplexer 132, a determination unit 133, a first encryption unit 134, a second encryption unit 135, a second multiplexer 136, a cipher unit 137, and a third logic gate 138.

The first bus interface 111 further receives an encryption enable signal PRIEN, a key KEY, a random number NONCE and setting information INF from the bus BUS, and stores them in the fourth register 131, where the encryption enable signal PRIEN is configured to enable the memory control device 110 to perform an encrypted write operation and/or a decryption read operation on the encrypted memory address EADDR, and encrypts and/or decrypts data for reading and writing according to the key KEY, random number NONCE, and setting information INF corresponding to the encrypted memory address EADDR.

According to some embodiments of the present invention, the user sets the encryption enable signal PRIEN, the encryption memory address EADDR, the key KEY, the random number NONCE, and the setting information INF stored in the fourth register 131 through the bus BUS and the bus interface 111. According to an embodiment of the present invention, when the operation signal HWRITE is in a writing state, it indicates that the encryption device 100 is performing a write operation. According to another embodiment of the present invention, when the operation signal HWRITE is in the reading state, it indicates that the encryption device 100 is performing a read operation. According to an embodiment of the present invention, the user can set the operation signal HWRITE to be in a writing state or a reading state through the bus BUS and the bus interface 111. The encrypted memory address EADDR, the key KEY, the random number NONCE, and the setting information INF will be described in detail below.

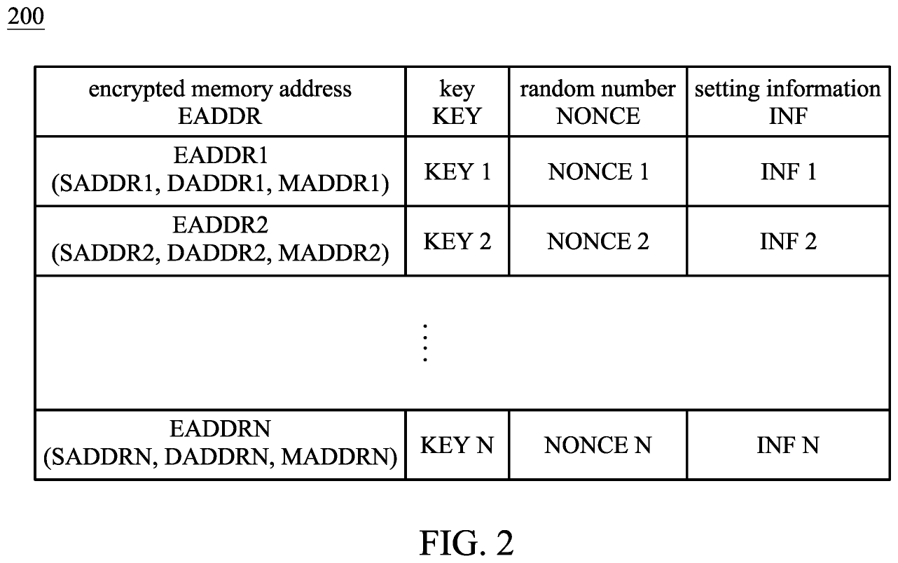

FIG. 2 shows a mapping table of encrypted memory address, key, random number, and setting information in accordance with an embodiment of the present invention. The mapping table 200 records the mapping relationship between the encrypted memory address EADDR, the key KEY, the random number NONCE, and the setting information INF of the protected area in the memory array 120.

As shown in the embodiment shown in FIG. 2, the protected area of the memory array 120 includes a first encrypted memory address EADDR1, a second encrypted memory address EADDR2 . . . and an N-th encrypted memory address EADDRN. The first encrypted memory address EADDR1 includes a first start memory address SADDR1, a first end memory address DADDR1, and a first message authentication code memory address MADDR1. The second encryption memory address EADDR2 includes a second start memory address SADDR2, a second end memory address DADDR2, and a second message authentication code memory address MADDR2. The N-th encryption memory address ADDRN includes an N-th start memory address SADDRN, an N-th end memory address DADDRN, and an N-th message authentication code memory address MADDRN.

In other words, when the decryption read operations and/or the encryption write operations are performed on the memory addresses between the first start memory address SADDR1 and the first end memory address DADDR1 of the memory array 120 minus 1, the memory addresses between the second start memory address SADDR2 and the second end memory address DADDR2 minus 1 . . . and the memory addresses between the N-th starting memory address SADDRN and the N-th end memory address DADDRN minus 1 of the memory array 120 (that is, the operating memory address HADDR between the above addresses and the encryption enabling signal PRIEN is in the enabled state), the encryption device 100 in FIG. 1 decrypts the ciphertext CT read from the memory array 120 and encrypts the write data WDATA to write into the memory array 120. According to other embodiments of the present invention, the user can further select which one of the first encrypted memory address EADDR1, the second encrypted memory address EADDR2 . . . and the N-th encrypted memory address EADDRN to perform decryption read operation and/or encrypted write operation.

As shown in FIG. 2, each of the first encrypted memory address EADDR1, the second encrypted memory address EADDR2 . . . and the N-th encrypted memory address EADDRN has a corresponding first key KEY1, second The key KEY2 . . . and N-th key KEYN, a corresponding first random number NONCE1, second random number NONCE2 . . . and N-th random number NONCEN, and a corresponding first setting information INF1, second setting information INF2 . . . and N-th setting information INFN. According to some embodiments of the present invention, the first setting information INF1, the second setting information INF2 . . . and the N-th setting information INFN can be user information, chip information, external memory information, version information, encryption and decryption algorithm, establishment date, etc., and can also be random variables like the random number NONCE.

According to an embodiment of the present invention, the user can set the first encrypted memory address EADDR1, the second encrypted memory address EADDR2 . . . and the N-th encrypted memory address EADDRN of the protected area through the bus BUS and the first bus interface 111, and can also set the first random number NONCE1, the second random number NONCE2 . . . and the N-th random number NONCEN stored in the fourth register 131. According to other embodiments of the present invention, the user can configure the first key KEY1, the second key KEY2 . . . and the N-th key KEYN stored in the fourth register 131 and the first setting information INF1, the second setting information INF2 . . . and the N-th setting information INFN stored in the fourth register 131 through the bus BUS and the first bus interface 111.

According to some embodiments of the present invention, the encrypted memory address EADDR in FIG. 1 is the first encrypted memory address EADDR1, the second encrypted memory address EADDR2 . . . or the N-th encrypted memory address EADDRN. Similarly, the starting memory address SADDRP is the first starting memory address SADDR1, the second starting memory address SADDR2 . . . or the N-th starting memory address SADDRN. The ending memory address DADDRP is the first end memory address DADDR1, the second number memory address DADDR2 . . . or the N-th end memory address DADDRN. The message authentication code memory address MADDRP is the first message authentication code memory address MADDR1, the second the message authentication code memory address MADDR2 . . . or the N-th message authentication code memory address MADDRN. P is 1, 2 . . . or N.

In addition, the first register 117, the second register 118, and the third register 119 in FIG. 1 are configured to store N sets of write locks WLK, N sets of key locks DLK, and N sets of message authentication codes MAC, which correspond to the first encrypted memory address EADDR1, the second encrypted memory address EADDR2 . . . and The N-th encrypted memory address EADDRN.

Referring to FIG. 1, the first multiplexer 132 outputs the key KEY, the random number NONCE, or the setting information INF according to the determination signal DET. When the determination unit 133 determines that the operating memory address HADDR is located in the encrypted memory address EADDR, the determination unit 133 outputs the determination signal DET and the key enabling signal KSEN according to the key lock DLK, the write lock WLK, the operation signal HWRITE, the message authentication code enable signal MACEN, and the protected area selection signal PRSEL.

In detail, when the operation signal HWRITE is in the writing state, the determination unit 133 enables the key enable signal KSEN based on the fact that the operating memory address HADDR is located at the encrypted memory address EADDR and the write lock WLK is in the unlocked state. When the operation signal HWRITE is in the reading state, the determination unit 133 enables the key enable signal KSEN based on the fact that the operating memory address HADDR is located at the encrypted memory address EADDR and the key lock DLK is in an unlocked state. When the message authentication code enable signal MACEN is in an enabled state, the determination unit 133 does not enable the key enable signal KSEN.

When the operation signal HWRITE is in the writing state or the reading state, the operating memory address HADDR is located in the encrypted memory address EADDR shown in FIG. 2, and the write lock WLK or key lock DLK is also in the unlocked state, the determination unit 133 uses the determination signal DET to control the first multiplexer 132, provides the random number NONCE corresponding to the encrypted memory address EADDR to the first encryption unit 134, and provides the key KEY corresponding to the encrypted memory address EADDR to the cipher unit 137. The first encryption unit 134 performs a first encryption mode calculation on the random number NONCE output by the first multiplexer 132 and the operating memory address HADDR to generate a first encryption result CNT and provides the first encryption result CNT to the second multiplexer 136. According to an embodiment of the present invention, the first encryption mode calculation is a counter mode.

When the message authentication code enable signal MACEN is enabled, the determination unit 133 selects the starting memory address SADDRP and the end memory address DADDRP corresponding to the encrypted memory address EADDRR according to the protected area selection signal PRSEL, provides the starting memory address SADDRP and the end memory address DADDRP to the second encryption unit 135, provides the encrypted memory address EADDR to the controller 112, and uses the determination signal DET to control the first multiplexer 132 to provide the setting information INF and the key KEY corresponding to the encrypted memory address EADDR to the second encryption unit 135 and the cipher unit 137 respectively. At the same time, the controller 112 uses the data input enable signal DINEN to notify the second encryption unit 135 that the input data is ready, and provides the ciphertext CT stored in the start memory address SADDRP of the memory array 120 and the lock data LOCK stored in the end memory address DADDRP to the second encryption unit 135. Therefore, the second encryption unit 135 performs a second encryption mode calculation on the starting memory address SADDRP, the end memory address DADDRP, the setting information INF, the ciphertext CT stored in the memory array 120, and the lock data LOCK to generate a second encryption result ECR.

For example, when the operating memory address HADDR is in the second encrypted memory address EADDR2, the determination unit 133 provides the second encrypted memory address EADDR2 to the controller 112, and the determination unit 133 provides the second starting memory address SADDR2 and the second end memory address DADDR2 to the second encryption unit 135. Then, the controller 112 reads the ciphertext CT and the locked data LOCK corresponding to the second encrypted memory address EADDR2 of the memory array 120, and provides the ciphertext CT and the locked data LOCK to the second encryption unit 135.

Subsequently, the second encryption unit 135 performs a second encryption mode calculation on the second start memory address SADDR2, the second end memory address DADDR2, the second setting information INF2, and the ciphertext CT and lock data LOCK stored in the memory array 120 to generate a second encryption result ECR. According to an embodiment of the present invention, the operation of the second encryption mode is a Cipher-block chaining Message Authentication Code (CBC-MAC) mode.

The second multiplexer 136 provides the first encryption result CNT or the second encryption result ECR to the cipher unit 137 according to the encryption selection signal SELE generated by the controller 112, so that the cipher unit 137 either uses the first encryption result CNT output by the second multiplexer 136 and the key KEY output by the first multiplexer 132 to generate the key stream KS, or it uses the second encryption result ECR output by the second multiplexer 136 and the key KEY output by the first multiplexer 132 to generate the digest information DSG. The digest information DSG is provided to the controller 112 and the second comparator CMP2. The third logic gate 138 outputs the key stream KS as the output key KO according to the key enable signal KSEN. According to an embodiment of the present invention, the third logic gate 138 performs a logic AND operation on the key enable signal KSEN and the key stream KS to generate the output key KO.

According to one embodiment of the present invention, before the second encryption unit 135 generates the second encryption result ECR, the cipher unit 137 uses the first encrypted result CNT from the first encryption unit 134 to generate the key stream KS, so that the second logic gate 116 decrypts the ciphertext CT stored in the memory array 120 and provides the decrypted data together with the locked data LOCK to the second encryption unit 135, and then the cipher unit 137 generates digest information DSG according to the second encryption result ECR generated by the second encryption unit 135. According to another embodiment of the present invention, the ciphertext CT can be directly provided to the second privacy unit 135 together with the locked data LOCK without decryption.

According to some embodiments of the present invention, the data processed by the second encryption unit 135 is a predetermined number of bits. When the bit number of the ciphertext CT and/or the locked data LOCK is less than the predetermined number of bits multiplied by an integer, the ciphertext CT and/or the locked data LOCK may be filled with zeros (zero padding) to complement the predetermined number of bits multiplied by an integer. For example, when the data processed by the second encryption unit 135 is 128 bits, if the ciphertext CT and the locked data LOCK are less than 128 bits or 128 bits multiplied by an integer, the ciphertext CT and the locked data LOCK will be filled with zeros to be 128 bits multiplied by an integer.

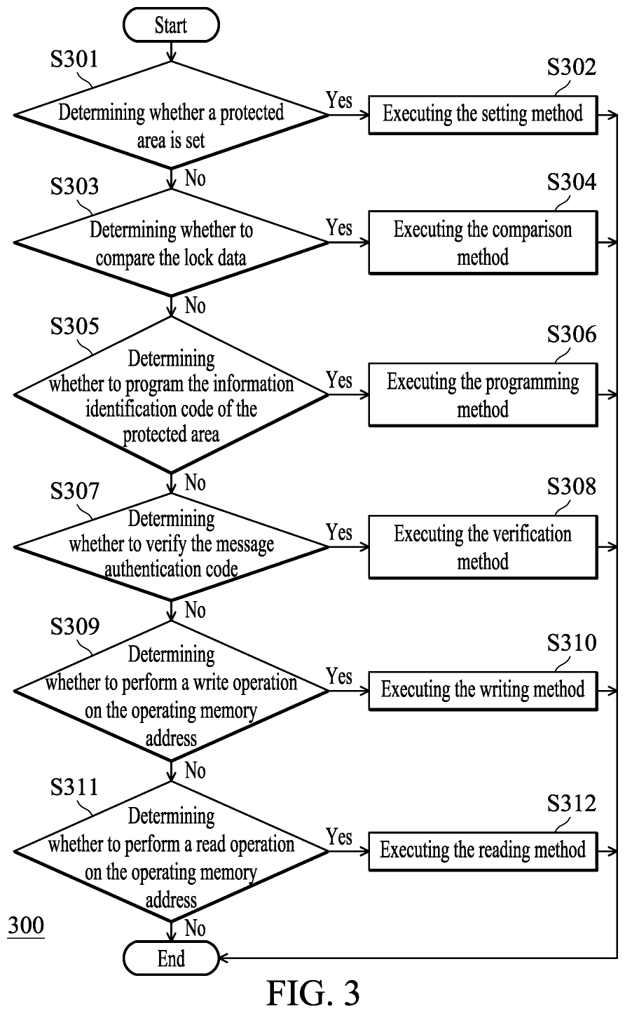

FIG. 3 is a flow chart showing the operation method in accordance with an embodiment of the present invention. The following description of the operation method 300 in FIG. 3 will be described in detail with the encryption device 100 in FIG. 1.

As shown in FIG. 3, the controller 112 determines whether the user sets the encrypted memory address EADDR, the key KEY, the random number NONCE, setting information INF, and encryption enabling signal PRIEN stored in the fourth register 131 through the bus BUS and the bus interface 111 (Step S301), where the mapping relationship among the encrypted memory address EADDR, the key KEY, the random number NONCE, and the setting information INF is shown in the mapping table 200 of FIG. 2. The encryption enable signal PRIEN is stored in the fourth register 131 for enabling or disabling whether the password device 130 performs encryption. In other words, the encryption enable signal PRIEN is configured to enable or disable the password device 130 to generate the output key KO.

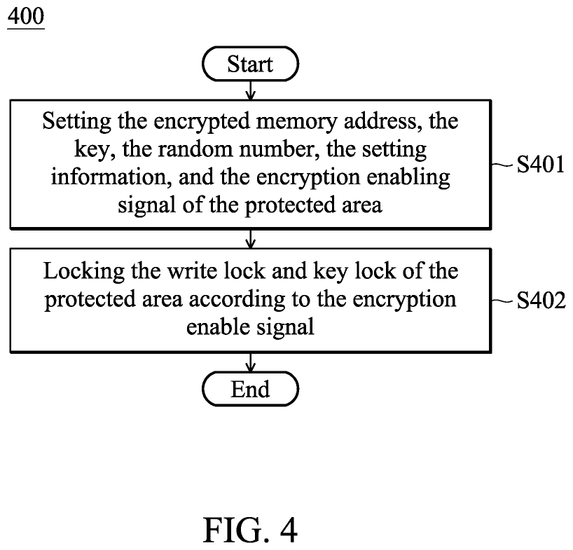

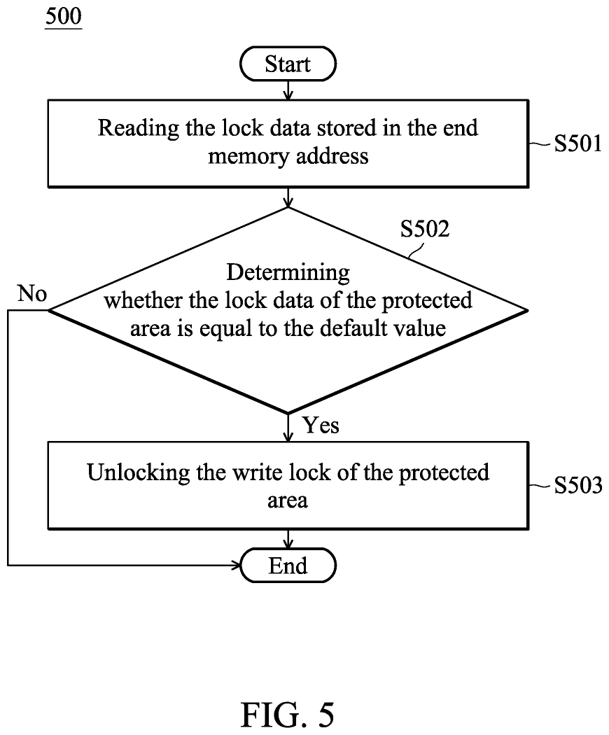

When the determination in Step S301 is YES, the controller 112 executes the setting method 400 in FIG. 4 (Step S302). When the determination in Step S301 is NO, the controller 112 determines whether to compare the lock data LOCK (Step S303). When the determination in Step S303 is YES, the controller 112 executes the comparison method 500 in FIG. 5 (Step S304). When the determination in Step S303 is NO, the controller 112 determines whether to program the information identification code MAC of the protected area (Step S305).

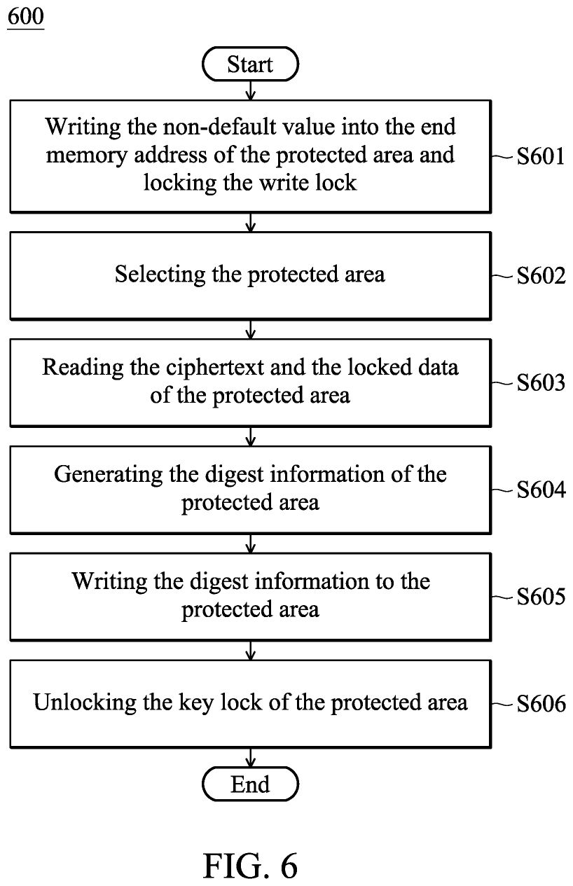

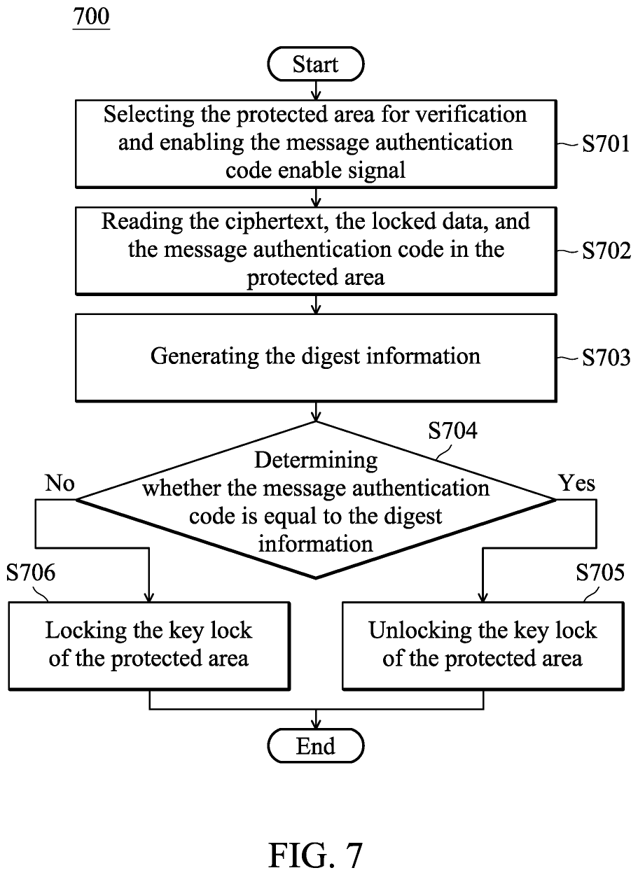

When the determination in Step S305 is YES, the controller 112 executes the programming method 600 of FIG. 6 (Step S306). When the determination in Step S305 is no, the controller determines whether to verify the message authentication code MAC (Step S307). When the determination in Step S307 is YES, the controller 112 executes the verification method 700 in FIG. 7 (Step S308). When the determination in Step S307 is NO, the controller 112 determines whether to perform a write operation on the operating memory address HADDR (Step S309).

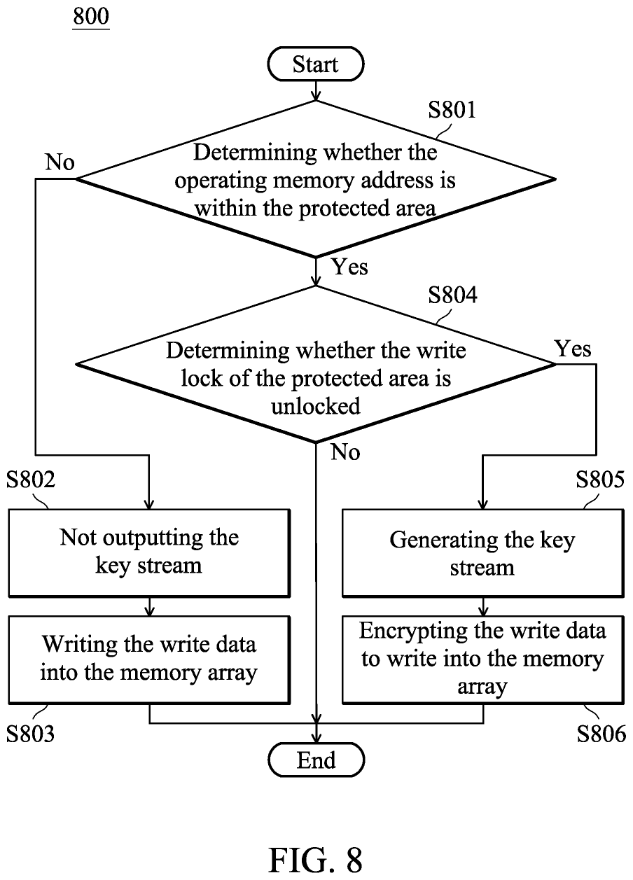

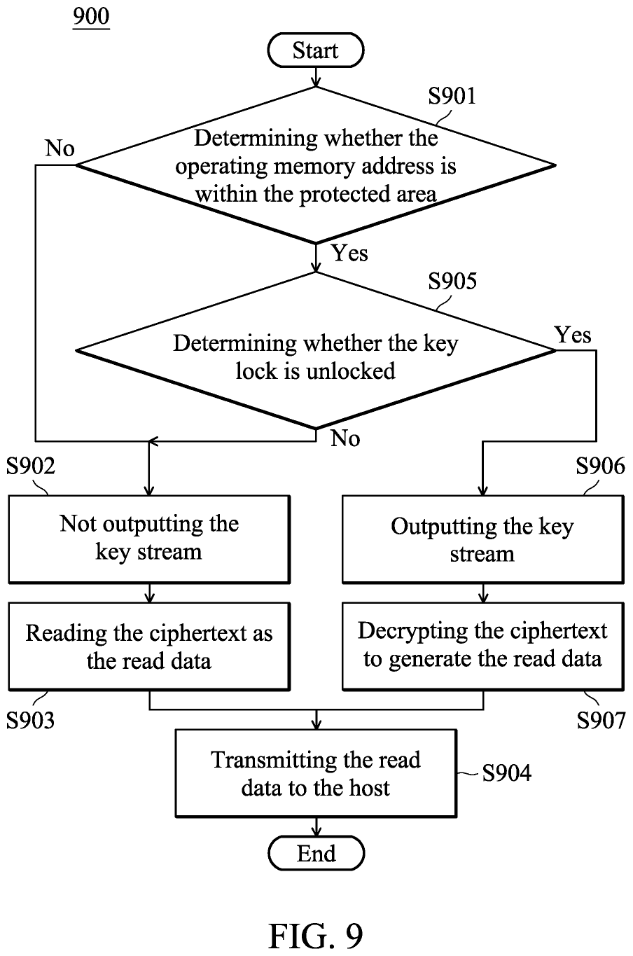

When the determination in Step S309 is YES, the controller 112 executes the writing method 800 of FIG. 8 (Step S310). When the determination in Step S309 is NO, the controller 112 determines whether to perform a read operation on the operating memory address HADDR (Step S311). When the determination in Step S311 is YES, the controller 112 executes the reading method 900 in FIG. 9 (Step S312). When the determination in writing method Step S312 is NO, the controller 112 ends the operation method 300.

According to some embodiments of the present invention, when the encryption device 100 is just turned on, the controller 112 must execute Step S302 and Step S304 at least once each, and then execute Step S310 and Step S306 at any time. The controller 112 must sequentially execute Step S302 and Step S308 at least once, and then execute Step S312 at any time. Step S302, Step S304, Step S306, or Step S308 may be executed at any time thereafter. According to an embodiment of the present invention, when the user sets the operation signal HWRITE to the writing state through the bus interface 111, the encryption device 100 executes the writing method 800. When the operation signal HWRITE is set to the reading state, the encryption device 100 executes the read method 900. In other words, in Step S309 and Step S311, Step S310 or Step S312 is executed according to the state of the operation signal HWRITE.

FIG. 4 is a flow chart showing a setting method in accordance with an embodiment of the present invention. As shown in FIG. 4, the controller 112 stores the encrypted memory address EADDR, the key KEY, the random number NONCE, the setting information INF, and the encryption enabling signal PRIEN set by the user through the bus interface 111 in the first Four registers 131 (Step S401). According to one embodiment of the present invention, the encrypted memory address EADDR, the key KEY, the random number NONCE, and the setting information INF set by the user are as shown in the mapping table 200 of FIG. 2, where the encrypted memory address EADDR includes a starting memory address SADDRP, an end memory address DADDRP, and an message authentication code memory address MADDRP.

Next, the controller 112 locks or unlocks the write lock WLK and key lock DLK of the encrypted memory address EADDR according to the encryption enable signal PRIEN (Step S402). According to an embodiment of the present invention, when the encryption enable signal PRIEN is in an enabled state, the controller 112 sets the write lock WLK and the key lock DLK corresponding to the encrypted memory address EADDR to a locked state. According to another embodiment of the present invention, when the encryption enable signal PRIEN is in a disabled state, the controller 112 sets the write lock WLK and the key lock DLK corresponding to the encrypted memory address EADDR to an unlocked state. In the following, the controller 112 sets the write lock WLK and the key lock DLK to a locked state according to the enabled encryption enable signal PRIEN to continue the description.

FIG. 5 is a flow chart showing a comparison method in accordance with an embodiment of the present invention. As shown in FIG. 5, the controller 112 uses the memory control signal EMICTL to read the lock data LOCK stored in the end memory address DADDRP to the buffer 113 (Step S501). According to some embodiments of the present invention, the end memory address DADDRP is the first end memory address DADDR1, the second end memory address DADDR2 . . . or the N-th end memory address DADDRN in FIG. 2.

Next, the first comparator CMP1 compares the lock data LOCK with the default value DEF to generate a first comparison result EQ1, and the controller 112 determines whether the lock data LOCK is equal to the default value DEF according to the first comparison result EQ1 (Step S502). When determining that the lock data LOCK is equal to the default value DEF, the controller 112 sets the write lock WLK to an unlocked state (Step S503). When determining that the lock data LOCK is not equal to the default value DEF, the controller 112 ends the comparison method 500 and sets the write lock WLK to a locked state.

FIG. 6 is a flow chart showing a programming method in accordance with an embodiment of the present invention. As shown in FIG. 6, when the user intends to program the message authentication code MAC of the encrypted memory address EADDR, the controller 112 writes the non-default value into the end memory address DADDRP of the encrypted memory address EADDR, and sets the write lock WLK corresponding to the memory address EADDR to a locked state (Step S601). For example, when the user intends to program the message authentication code MAC of the second encrypted memory address EADDR2, the controller 112 writes a non-default value into the lock data LOCK corresponding to the second encrypted memory address EADDR2 of the memory array 120 in Step S601, and sets the write lock WLK corresponding to the second encrypted memory address EADDR2 to a locked state.

Next, the controller 112 uses the protected area selection signal PRSEL to select the message authentication code MAC corresponding to the encrypted memory address EADDR for programming, and sets the message authentication code enable signal MACEN to an enabled state (Step S602). As in the above-mentioned embodiment, when the user intends to program the message authentication code MAC of the second encrypted memory address EADDR2, the controller 112 uses the protected area selection signal PRSEL to select the second encrypted memory address EADDR2, and sets the message authentication code signal MACEN to an enabled state to enable the second encryption unit 135 and disable the first encryption unit 134.

Subsequently, the controller 112 uses the memory control signal EMICTL to read the ciphertext CT and the locked data LOCK of the encrypted memory address EADDR (Step S603). As in the above embodiment, when the user programs the message authentication code MAC to the second encrypted memory address EADDR2, the controller 112 uses the memory control signal EMICTL to read the ciphertext CT and lock data LOCK corresponding to the second encrypted memory address EADDR2, and provides the read ciphertext CT and locked data LOCK to the second encryption unit 135.

Next, the password device 130 generates digest information DSG (Step S604). As in the above embodiment, the second encryption unit 135 performs the second encryption mode operation on the ciphertext CT and locked data LOCK corresponding to the second encrypted memory address EADDR2, the second start memory address SADDR2, the second end memory address DADDR2, and the second setting information INF2 corresponding to the second encryption memory address EADDR2 provided by the first multiplexer 132 to generate the second encryption result ECR. According to an embodiment of the present invention, the second encryption mode operation is a Cipher-block chaining Message Authentication Code mode. Subsequently, the second multiplexer 136 provides the second encryption result ECR to the cipher unit 137 according to the encryption selection signal SELE provided by the controller 112, and the cipher unit 137 uses the second encryption key KEY2 and the second encryption result ECR corresponding to the second encryption memory address EADDR2 to generate digest information DSG.

The controller 112 writes the digest information DSG into the corresponding message authentication code memory address MADDRP as the message authentication code MAC (Step S605), and sets the key lock DLK corresponding to the encrypted memory address EADDR to an unlocked state (Step S606). As in the above embodiment, the controller 112 uses the memory control signal EMICTL to write the digest information DSG into the second message authentication code memory address MADDR2 of the memory array 120, and sets the key lock DLK corresponding to the second encrypted memory address EADDR2 stored in the first temporary register 117 in FIG. 1 to an unlocked state.

FIG. 7 is a flow chart showing a verification method in accordance with an embodiment of the present invention. As shown in FIG. 7, when the user intends to verify the encrypted memory address EADDR, the controller 112 uses the protected area selection signal PRSEL to select the encrypted memory address EADDR for verification, and sets the message authentication code enable signal MACEN to an enabled state (Step S701). For example, when the user intends to verify the second encrypted memory address EADDR2 in FIG. 2, the controller 112 uses the protected area selection signal PRSEL to select the second encrypted memory address EADDR2, and sets the message authentication code enable signal MACEN to the enabled state.

The controller 112 uses the memory control signal EMICTL to read the ciphertext CT, the locked data LOCK, and the message authentication code MAC in the protected area (Step S702). As in the above embodiment, the controller 112 reads the ciphertext CT, the locked data LOCK, and the message authentication code MAC corresponding to the second encrypted memory address EADDR2, where the ciphertext CT and the locked data LOCK are provided to the second encryption unit 135 and the message authentication code MAC is stored in the third register 119. Next, the password device 130 generates the digest information DSG (Step S703), where the method of generating the digest information DSG is as described in Step S604, which will not be repeated here.

After Step S703, the second comparator CMP2 compares whether the message authentication code MAC is equal to the digest information DSG generated by the password device 130 to generate a second comparison result EQ2, and the controller 112 determines whether the message authentication code MAC is equal to the digest information DSG according to the second comparison result EQ2 (Step S704).

When the determination in Step S704 is YES, the controller 112 sets the key lock DLK corresponding to the encrypted memory address EADDR to an unlocked state (Step S705). When the determination in Step S704 is NO, the controller 112 sets the key lock DLK corresponding to the encrypted memory address EADDR to a locked state (Step S706). As in the above-mentioned embodiment, when the message authentication code MAC stored in the second message authentication code memory address MADDR2 of the second encrypted memory address EADDR2 is equal to the digest information DSG generated by the password device 130, it means that the ciphertext CT stored in the second encrypted memory address EADDR2 has not been tampered with, so the key lock DLK is set to the unlocked state. When the message authentication code MAC is not equal to the digest information DSG, it means that the ciphertext CT stored in the second encrypted memory address EADDR2 has been changed, so the key lock DLK is set to the locked state to protect data security.

FIG. 8 is a flow chart showing a writing method in accordance with an embodiment of the present invention. As shown in FIG. 8, the determination unit 133 determines whether the operating memory address HADDR input by the user through the bus BUS is within the range of the encrypted memory address EADDR (Step S801). For example, the determination unit 133 determines whether the operating memory HADDR received from the bus interface 111 is within the ranges of the first encrypted memory address EADDR1, the second encrypted memory address EADDR2, and the N-th encrypted memory address EADDRN in FIG. 2. According to an embodiment of the present invention, when the writing method 800 is executed, the operation signal HWRITE is in a writing state.

When the determination in Step S801 is NO, the determination unit 133 disables the key enable signal KSEN, so that the password device 130 stops outputting the key stream KS as the output key KO (Step S802). Moreover, the controller 112 directly writes the write data WDATA into the memory array 120 (Step S803), without performing encryption.

When the determination in Step S801 is YES, the determination unit 133 determines whether the write lock WLK corresponding to the encrypted memory address EADDR is in the unlocked state (Step S804). For example, when it is determined in Step S801 that the operating memory address HADDR falls within the second encrypted memory address EADDR2, the determination unit 133 in Step S804 determines whether the write lock WLK corresponding to the second encrypted memory address EADDR2 is in the locked state.

When the determination in Step S804 is YES, the password device 130 generates the key stream KS (Step S805), and the first logic gate 115 uses the key stream KS to encrypt the write data WDATA, thereby generating encrypted write data EWDATA. The encrypted write data EWDATA is then written into the operating memory address HADDR of the memory array 120 as ciphertext CT (Step S806). When the determination in Step S804 is NO, the writing method 800 ends. According to some embodiments of the present invention, when the determination in Step S804 is NO, the encryption device 100 does not write the write data WDATA into the memory array 120.

For example, in Step S805, the determination unit 133 provides the operating memory address HADDR to the first encryption unit 134, so that the first encryption unit 134 performs the first encryption mode calculation on the operating memory address HADDR and the corresponding random number NONCE (as in the above-mentioned embodiment, that is, the second random number NONCE2) to generate the first encryption result CNT. The second multiplexer 136 provides the first encryption result CNT to the cipher unit 137 according to the encryption selection signal SELE provided by the controller 112. The cipher unit 137 generates a key stream KS according to the first encryption result CNT and the corresponding key KEY (as in the above-mentioned embodiment, that is, the second key KEY2).

Next, the determination unit 133 enables the key enable signal KSEN according to the operation signal HWRITE is in the writing state, the operating memory address HADDR is located in the encrypted memory address EADDR, and the write lock WLK is in the unlocked state. The third logic gate 138 outputs the key stream KS as the output key KO according to the enabled key enable signal KSEN, so that the first logic gate 115 encrypts the write data WDATA according to the output key KO to generate the encrypted write data EWDATA. The controller 112 further utilizes the memory control signal EMICTL to write the encrypted write data EWDATA into the operating memory address HADDR of the memory array 120 as the ciphertext CT.

FIG. 9 is a flow chart showing a reading method in accordance with an embodiment of the present invention. As shown in FIG. 9, first, the determination unit 133 determines whether the operating memory address HADDR input by the user is within the range of the encrypted memory address EADDR (Step S901). For example, the determination unit 133 determines whether the operating memory HADDR is within the ranges of the first encrypted memory address EADDR1, the second encrypted memory address EADDR2, and the N-th encrypted memory address EADDRN in FIG. 2.

When the determination in Step S901 is NO, the determination unit 133 disables the key enable signal KSEN, so that the password device 130 does not output the key stream KS and outputs the output key KO as a low logic level (Step S902). Moreover, the controller 112 directly reads the ciphertext CT stored in the operating memory address HADDR of the memory array 120 as the read data RDATA (Step S903), without decryption. Next, the controller 112 transmits the read data RDATA to the host through the bus interface 111 and the bus BUS (Step S904). In detail, since the operating memory address HADDR is not in the encrypted memory address EADDR, the password device 130 does not need to generate the output key KO, and the controller 112 can directly read the corresponding data in the memory array 120.

When the determination in Step S901 is YES, the determination unit 133 determines whether the key lock DLK corresponding to the encrypted memory address EADDR is in an unlocked state (Step S905). For example, when the determination unit 133 determines in Step S901 that the operating memory address HADDR is located in the second encrypted memory address EADDR2, the determination unit 133 in Step S905 determines whether the key lock DLK of the second encrypted memory address EADDR2 is in the unlocked state.

When the determination unit 133 in Step S905 determines that the key lock DLK is not in the unlocked state, that is, when the key lock DLK is in the locked state, Step S902 is executed. According to an embodiment of the present invention, when it is determined that the operating memory address HADDR is located at the encrypted memory address EADDR and the key lock DLK is in the locked state, the password device 130 does not output the key stream KS as the output key KO, so that the corresponding ciphertext CT cannot be decrypted, thereby protecting the security of the ciphertext CT. According to an embodiment of the present invention, when it is found that the key lock DLK is in the locked state, the verification method 700 can be executed through Step S307 of the operation method 300 to set the key lock DLK to the unlocked state.

When the determination unit 133 determines in Step S905 that the key lock DLK is in an unlocked state, the password device 130 outputs the key stream KS as the output key KO (Step S906). More specifically, the determination unit 133 enables the key enable signal KSEN according to the operation signal HWRITE being in the reading state, the operating memory address HADDR being in the encrypted memory address EADDR, and the corresponding key lock DLK being in the unlocked state. The third logic gate 138 outputs the key stream KS as the output key KO according to the enabled key enable signal KSEN. After Step S906, the second logic gate 116 performs the exclusive OR logic operation on the output key KO and the ciphertext CT read from the operating memory address HADDR of the memory array 120 to generate the read data RDATA (Step S907). Next, the read data RDATA is transmitted to the host through the bus interface 111 and the bus BUS (Step S904).

In detail, when the key lock DLK is in the unlocked state, the determination unit 133 generates a determination signal DET according to the key lock DLK, and the corresponding random number NONCE (as in the above-mentioned embodiment, that is, the second random number NONCE2 corresponding to the second encrypted memory EADDR2) is provided to the first encryption unit 134. The first encryption unit 134 performs the first encryption mode calculation on the operating memory address HADDR and the random number NONCE provided by the determination unit 133 to generate a first encryption result CNT. The second multiplexer 136 provides the first encryption result CNT to the cipher unit 137 according to the encryption selection signal SELE provided by the controller 112, and the cipher unit 137 uses the first encryption result CNT output by the second multiplexer 136 and the first The corresponding key KEY output by the multiplexer 132 (as in the above-mentioned embodiment, that is, the second key KEY2 corresponding to the second encrypted memory address EADDR2) to generate a key stream KS (Step S906).

The third logic gate 138 outputs the key stream KS as the output key KO according to the enabled key enable signal KSEN. The controller 112 uses the memory control signal EMICTL to read the ciphertext CT of the operating memory address HADDR of the memory array 120 and temporarily stores the ciphertext CT in the buffer 113. The second logic gate 116 decrypts the read ciphertext CT into the read data RDATA according to the output key KO (Step S907). Next, the controller 112 transmits the decrypted read data RDATA to the host through the bus interface 111 and the bus BUS (Step S904).

The present invention proposes encryption devices and operation methods thereof, which set a write lock according to user's need, so as to strengthen the protection of the content of the ciphertext and prevent the possibility of it being tampered with. In addition, the encryption device proposed by the present invention uses a Cipher-block chaining Message Authentication Code (CBC-MAC) mode to generate digest information and store the digest information in the memory array. This provides an additional protection for the ciphertext to ensure the security and integrity of internal programs. Furthermore, the encryption device proposed herein is locked with keys, so that the digest information must be confirmed to unlock the subsequent decryption process during the read operation, so as to prevent data that has been tampered with from flowing into the encryption device.

Although some embodiments of the present disclosure and their advantages have been described in detail, it should be understood that various changes, substitutions and alterations can be made herein without departing from the spirit and scope of the disclosure as defined by the appended claims. For example, it will be readily understood by those skilled in the art that many of the features, functions, processes, and materials described herein may be varied while remaining within the scope of the present disclosure. Moreover, the scope of the present application is not intended to be limited to the particular embodiments of the process, machine, manufacture, composition of matter, means, methods and steps described in the specification. As one of ordinary skill in the art will readily appreciate from the disclosure of the present disclosure, processes, machines, manufacture, compositions of matter, means, methods, or steps, presently existing or later to be developed, that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. An encryption device, comprising:
a memory array, configured to store lock data; and
a memory control device, determining whether the lock data is equal to a predetermined value according to an operation instruction, wherein when the memory control device determines that the lock data is equal to the predetermined value, the memory control device performs a logic operation on write data and an output key to generate encrypted write data, and writes the encrypted write data to the memory array as ciphertext.

2. The encryption device as defined in claim 1, wherein the memory control device comprises:
a first register, configured to store a write lock;
a second register, configured to store a key lock;
a third register, configured to store a message authentication code of a message authentication code memory address in the memory array;
a first comparator, configured to compare the lock data with the predetermined value to generate a first comparison result;
a second comparator, configured to compare digest information with the message authentication code to generate a second comparison result;
a bus interface, receiving the operation instruction, an encryption enable signal, the write data, an operating memory address, an encrypted memory address, a key, a random number, and setting information, wherein the key, the random number, and the setting information correspond to the encrypted memory address, wherein the encrypted memory address comprises a starting memory address, an end memory address, and a message authentication code memory address, wherein the encrypted data is stored in the starting memory address and the lock data is stored in the end memory address;
a memory interface, coupled to the memory array;
a buffer, coupled to the memory interface, wherein when the first comparator compares the lock data with the predetermined value, the buffer temporarily stores the lock data, wherein the buffer temporarily stores the encrypted write data and the ciphertext;
a first logic gate, performing an exclusive OR logic operation on the write data and the output key to generate the encrypted write data;
a second logic gate, performing the exclusive OR logic operation on the ciphertext and the output key to generate read data; and
a controller, controlling the memory array using a memory control signal through the memory interface according to the operation instruction and the operation memory address, and accessing the memory array through the buffer and the memory interface;
wherein the controller determines whether the lock data is equal to the predetermined value according to the first comparison result;
wherein when the lock data is equal to the predetermined value, the controller enables the first register using a write lock enable signal and sets the write lock to an unlocked state using a write lock input signal;
wherein when the lock data is not equal to the predetermined value, the controller sets the write lock to a locked state.

3. The encryption device as defined in claim 2, wherein the memory control device further comprises:
a password device, comprising:
a fourth register, configured to store the encryption enable signal, the encrypted memory address, the key, the random number, and the setting information;
a first multiplexer, outputting the key, the random number, or the setting information according to a determination signal;
a determination unit, wherein when the determination unit determines that the operating memory address is in the encrypted memory address, the determination unit generates the determination signal and a key enable signal according to the key lock, the write lock, an operation signal, a message authentication code signal, and a protected area selection signal;
a first encryption unit, performing a first encryption mode calculation on the first random number output by the first multiplexer and the operating memory address to generate a first encryption result;
a second encryption unit, receiving the ciphertext stored in the memory array and the lock data and performing a second encryption mode calculation on the ciphertext, the lock data, the setting information output by the first multiplexer, and a starting memory address and an end memory address of the encrypted memory address to generate a second encryption result;
a cipher unit, using the first encryption result and the key output by the first multiplexer to generate a key stream, or using the second encryption result and the key output by the first multiplexer to generate digest information;
a second multiplexer, providing either the first encryption result or the second encryption result to the cipher unit according to an encryption selection signal generated by the controller; and
a third logic gate, performing a logic AND operation on the key stream and the key enable signal to generate the output key.

4. The encryption device as defined in claim 3, wherein when a user sets the encryption enable signal to an enabled state through the bus interface, the controller sets the write lock and the key lock to a locked state;
wherein the controller does not write the write data into the encrypted memory address according to the write lock being in the locked state;
wherein the third logic gate does not output the key stream as the output key according to the key enable signal being in the locked state;
wherein the user further sets the encrypted memory address, the key, the random number, and the setting information through the bus interface.

5. The encryption device as defined in claim 4, wherein the controller writes a value into the end memory address as the lock data, and the value and the predetermined value are different;
wherein the controller further reads the ciphertext and the lock data being the value from the encrypted memory address;
wherein the cipher unit generates the digest information corresponding to the encrypted memory address;
wherein the controller writes the digest information generated by the cipher unit into the message authentication code memory address as the message authentication code, and sets the key lock of the encrypted memory address to an unlocked state.

6. The encryption device as defined in claim 5, wherein the controller selects the encrypted memory address using the protected area selection signal to verify the message authentication code and to enable the message authentication code signal;
wherein the controller reads the ciphertext, the lock data, and the message authentication code of the encrypted memory address;
wherein the cipher unit generates the digest information according to the ciphertext and the lock data;
wherein the second comparator compares the digest information with the message authentication code;
wherein when the digest information is equal to the message authentication code, the controller sets the key lock to the unlocked state;
wherein when the digest information is not equal to the message authentication code, the controller sets the key lock to the locked state.

7. The encryption device as defined in claim 6, wherein the determination unit determines whether the operating memory address is in the encrypted memory address;
wherein when the operating memory address is in the encrypted memory address, when the operation signal is in a write operation, and when the write lock is in the unlocked state, the determination unit enables the key enable signal;
wherein the cipher unit uses the first encryption result generated by the first encryption unit and the key to generate the key stream, and the third logic gate outputs the key stream as the output key according to the enabled key enable signal;
wherein the first logic gate encrypts the write data using the output key to generate encrypted write data;
wherein the controller writes the encrypted write data to the operating memory address of the memory array as encrypted data.

8. The encryption device as defined in claim 6, wherein the determination unit determines whether the operating memory address is in the encrypted memory address;
wherein when the operating memory address is in the encrypted memory address, the operation signal is in a reading state, and the key lock is in the unlocked state, the determination unit enables the key enable signal;
wherein the third logic gate outputs the key stream as the output key according to the key enable signal;
wherein the second logic gate decrypts the ciphertext stored in the operating memory address of the memory array by using the output key as the read data.

9. The encryption device as defined in claim 3, wherein the first encryption mode calculation is a counter mode, wherein the second encryption mode calculation is a Cipher-block chaining Message Authentication Code (CBC-MAC) mode.

10. An operation method adapted to an encryption device, wherein the encryption device comprises a memory array, and the memory array stores lock data, wherein the operation method comprises:
determining whether lock data is equal to a predetermined value;
when it is determined that the lock data is equal to the predetermined value, setting a write lock to an unlocked state;
when the write lock is in the unlocked state, encrypting write data with an output key to generate encrypted write data; and
writing the encrypted write data into the memory array.

11. The operation method as defined in claim 10, further comprising:
when an encrypted memory address is set, executing a setting method;
when the lock data is compared, executing a comparison method;
when a message authentication code of the encrypted memory address is programmed, executing a programming method;
when the message authentication code is verified, executing a verification method;
when performing a write operation on the memory array, executing a writing method; and
when performing a read operation on the memory array, executing a reading method;
wherein before the writing method is executed, the setting method and the comparison method must be sequentially executed at least once, wherein before the reading method is executed, the setting method, the programming method, and the verification method must be sequentially executed at least once.

12. The operation method as defined in claim 11, wherein the setting method further comprises:
setting the encrypted memory address, a key, a random number, setting information, and an encrypted enable signal through a bus interface, wherein the key, the random number, and the setting information correspond to the encrypted memory address, wherein the encrypted memory address comprises a starting memory address, an end memory address, and a message authentication code memory address; and
setting the write lock and a key lock corresponding to the encrypted memory address to a locked state.

13. The operation method as defined in claim 12, wherein the comparison method further comprises:
reading the lock data of the encrypted memory address, wherein the lock data is stored in the end memory address;
determining whether the lock data is equal to the predetermined value;
when it is determined that the lock data is equal to the predetermined value, setting the write lock to the unlocked state; and
when it is determined that the lock data is not equal to the predetermined value, setting the write lock to the locked state.

14. The operation method as defined in claim 13, wherein the programming method further comprises:
writing a value into the end memory address as the lock data, wherein the value is not equal to the predetermined value;
selecting the encrypted memory address to be programmed;
reading the ciphertext and the lock data of the encrypted memory address of the memory array;
generating digest information of the encrypted memory address according to the ciphertext, the lock data, the starting memory address, the end memory address, and the setting information;
writing the digest information to the message authentication code memory address; and
after the digest information is written, setting the key lock to the unlocked state.

15. The operation method as defined in claim 14, wherein the step of generating the digest information of the encrypted memory address according to the ciphertext, the lock data, the starting memory address, the end memory address, and the setting information further comprises:
performing an encryption mode calculation on the ciphertext, the lock data, the starting memory address, the end memory address, and the setting information to generate an encryption result; and
generating the digest information according to the encryption result and the key;
wherein the encryption mode calculation is a Cipher-block chaining Message Authentication Code (CBC-MAC) mode.

16. The operation method as defined in claim 14, wherein the verification method further comprises:
selecting the encrypted memory address to be verified;
reading the ciphertext, the lock data, and the message authentication code of the encrypted memory address of the memory array;
generating the digest information of the encrypted memory address according to the ciphertext, the lock data, the starting memory address, the end memory address, and the setting information;
determining whether the message authentication code is equal to the digest information;
when the message authentication code is equal to the digest information, setting the key lock of the encrypted memory address to the unlocked state; and
when the message authentication code is not equal to the digest information, setting the key lock of the encrypted memory address to the locked state.

17. The operation method as defined in claim 16, wherein the writing method further comprises:
receiving an operating memory address to perform a write operation;
determining whether the operating memory address is in the encrypted memory address;
when the operating memory address is in the encrypted memory address, determining whether the write lock is in the unlocked state;
when the write lock is in the unlocked state, generating a key stream according to the operating memory address, the random number, and the key;
encrypting the write data by using the key stream to generate the ciphertext; and
writing the ciphertext to the memory array.

18. The operation method as defined in claim 17, wherein the step of generating the key stream according to the operating memory address, the random number, and the key further comprises:
performing an encryption mode calculation on the operating memory address and the random number to generate an encrypted result;
generating the key stream according to the encryption result and the key;
enabling a key enable signal according to the operating memory address being in the encrypted memory address and the write lock being in the unlocked state; and
outputting the key stream as an output key according to the key enable signal, wherein the output key is further configured to encrypt the write data;
wherein the encryption mode calculation is a counter mode.

19. The operation method as defined in claim 16, wherein the reading method further comprises:
receiving an operating memory address to perform a read operation;
determining whether the operating memory address is in the encrypted memory address;
when the operating memory address is in the encrypted memory address, determining whether the key lock is in the unlocked state;
when the key lock is in the unlocked state, generating a key stream according to the operating memory address, the random number, and the key;
decrypting the ciphertext by using the key stream to generate read data; and
providing the read data to a host.

20. The operation method as defined in claim 19, wherein the reading method further comprises:
when the operating memory address is not in the encrypted memory address, not generating the key stream;
when the key lock is in the locked state, not generating the key stream; and
directly reading the ciphertext of the operating memory address of the memory array as the read data.
